(19) United States
(12) Patent Application Publication
(10) Pub. No.: US 2025/0330115 A1
(43) Pub. Date: Oct. 23, 2025

(54) FASTENER FOR A PHOTOVOLTAIC MODULE FRAME, AND METHOD FOR FASTENING THE LATTER

(71) Applicant: HANWHA Q CELLS GMBH, Bitterfeld-Wolfen (DE)

(72) Inventors: Uwe Matthess, Bitterfeld-Wolfen (DE); Uwe Albrecht, Bitterfeld-Wolfen (DE); Heiko Molitor, Bitterfeld-Wolfen (DE)

(21) Appl. No.: 18/870,741

(22) PCT Filed: May 30, 2023
(86) PCT No.: PCT/EP2023/064397

§ 371 Date: Dec. 2, 2024

(30) Foreign Application Priority Data
Jun. 2, 2022 (DE) 10 2022 113 986.7

(51) Int. Cl. H02S 30/10; H02S 20/00

(52) U.S. Cl. CPC H02S 30/10; H02S 20/00

(57) ABSTRACT

A fastener for photovoltaic module frames on a substructure comprises a mounting body and a locking element. The mounting body comprises a first engaging portion for engaging in the substructure and at least one second engaging portion for engaging in the photovoltaic module frame. The locking element is designed to fix the mounting body to the substructure, so that when the mounting is effected in this way, the photovoltaic module frame is held to the substructure only via the mounting body.

### PRIORITY CLAIM

The present application is a National Phase entry of PCT Application No. PCT/EP2023/064397, filed May 30, 2023, which claims priority from German Patent Application 102022113986.7, filed Jun. 2, 2022, the disclosures of which are hereby incorporated by reference herein in their entirety.

### FIELD OF THE INVENTION

The present invention relates to a fastener of a photovoltaic module frame on a substructure and to a method for fastening a photovoltaic module frame.

### BACKGROUND

Photovoltaic modules are mounted on a substructure using a photovoltaic module frame. This mounting must be able to withstand strong mechanical stresses, such as those caused by strong winds.

With conventional mountings, for example, holding elements are screwed onto the substructure, into which the photovoltaic module frame is hung, so that when mounted at an angle (for example on a roof), the frame is only held by the higher section of the frame. Other conventional mountings use a friction-locked connection, in which the photovoltaic module frame is screwed or pressed onto the substructure using a clamp, for example. One advantage of these mountings is that there is no need for openings or holes in the frame, which increases long-term stability. Holes, openings or slots in the frame are otherwise a frequent cause of cracks or similar damage, which jeopardize a secure hold in the wind in the long term. One disadvantage, however, is that friction-locked connections can become loose in the long term. There are also conventional mounting brackets in which the mounting of the photovoltaic module frames is not exclusively effected by a force. For example, hook-shaped elements can be used that grip the photovoltaic module frame from above in order to hold the frame. However, these mountings have the disadvantage that gripping around the frame leads to a protrusion, which is a potential source for the accumulation of dirt and moisture, from which one would like to keep the photovoltaic modules as free as possible, as this impairs the efficiency of the photovoltaic module.

There is therefore a need for alternative fastening options that firmly connect the photovoltaic module frame to the substructure without damaging the frame through openings and at the same time do not form protruding sections where dirt can accumulate.

### BRIEF DESCRIPTION OF THE INVENTION

At least part of the above problems are solved by a fastener or mounting for a photovoltaic module frame according to claim 1 and a method for fastening a photovoltaic module frame according to claim 11. The dependent claims define further advantageous embodiments of the objects of the independent claims.

The present invention relates to a fastener for a photovoltaic module frame on a substructure. The fastener comprises a mounting body and a locking element. The mounting body comprises a first engaging portion for engaging with the substructure and at least one second engaging portion for engaging with the photovoltaic module frame. The locking element is designed to fix the mounting body to the substructure, so that the photovoltaic module frame is only held to the substructure via the mounting body when the fastening (mounting) is effected in this way.

In particular, the locking element does not engage in the photovoltaic module frame or hold it directly. The mounting is rather indirect via the mounting body that holds the photovoltaic module frame. Although the locking element can abut the photovoltaic module frame horizontally (in the sense of a spacer), it should not extend vertically (opposite to the direction of light incidence) beyond the photovoltaic module frame or overlap the photovoltaic module frame.

The term “engaging” should generally be understood as an interlocking connection (e.g. hooking). The engaging portion can, for example, be designed as flaps or tabs with slots for holding a section of the frame. The direction of light incidence is the direction from or in which the light should fall on the photovoltaic modules after installation. It is generally directed in the opposite direction to the substructure.

The photovoltaic module frame can have a protruding portion (section) that extends parallel to a light incidence surface of an installed photovoltaic module. Optionally, the at least one second engaging portion then comprises a first portion having a first slot and a second portion having a second slot that are bent from a planar portion of the mounting body. The first slot and the second slot may be formed at different levels with respect to the planar portion in order to receive the protruding portion of the photovoltaic module frame and to clamp it during fixing by the locking element. By engaging and clamping, this mounting results in a force-fitting and interlocking connection. It is advantageous if the engagement in the substructure allows a predetermined amount of play or free space so that the mounting body can tilt as a result of the different levels before being fixed by the locking element.

Optionally, the at least one second engaging portion comprises four portions each having a slot formed as monolithic parts in corner regions of the mounting body. Of these, two slots may be configured to grip (engage) a first photovoltaic module frame, and two further slots may be configured to grip (engage) a second photovoltaic module frame. The locking element may be configured to form a spacer between the first photovoltaic module frame and the second photovoltaic module frame. As this prevents the photovoltaic module frame from sliding out of the slots, it can reliably prevent the photovoltaic module frame from detaching from the substructure after mounting.

Optionally, the mounting body comprises a through-opening and the locking element comprises a bolt and a holding element. The bolt can be guided through the through-opening and the holding element, and the holding element together with the bolt can have a T-shaped form to hold the mounting body over the through-opening. The holding element itself can be designed as a U-profile and can be moved in the direction of the mounting body when tightened by the bolt (e.g. a screw) and braced with the mounting body. The holding element can have a smaller extension along a light incidence direction than the photovoltaic module frame. This prevents a protrusion or projection where water or dirt could otherwise collect.

Optionally, the holding element comprises a latching mechanism configured to latch into the through-opening or into the substructure and thus block the photovoltaic module frame from sliding out of the second engaging portion. As the holding element acts as a spacer, the photovoltaic modules can be held in place by the bolt even without screwing. They can no longer slide out of the slots. Optionally, the latching mechanism is a separate component from the holding element and is only latched into the groove of the substructure. The latching mechanism is guided through the through-opening (e.g. with little or no play).

Optionally, the substructure comprises a recess, in particular a through-opening or a longitudinally extending groove. The first engaging portion and/or the recess can be configured to provide an interlocking connection between the substructure and the first engaging portion (e.g. by latching, hooking, underhooking by twisting, locking or interlocking).

Optionally, the mounting body comprises a further first engaging portion, wherein the first engaging portion and the further first engaging portion are formed as T-shaped projections at opposite ends of the mounting body in order to be able to hook both into the recess.

Optionally, the mounting body comprises at least one reinforcing section extending from the mounting body in a same direction as the first engaging portion. The reinforcing section(s) can be formed as reinforcing flaps (tabs) and are intended to prevent bending. In addition, the mounting body is thereby better held on the substructure, so that a displacement along the substructure is possible, but no displacements of the mounting body perpendicular to a longitudinal extension of the substructure is possible.

Optionally, the mounting body comprises a planar portion from which the first engaging portion(s) and the at least one second engaging portion each extend as a projection in opposite directions. After mounting, the planar portion forms a spacer between the photovoltaic module frame and the substructure. The photovoltaic module frame is therefore not in direct contact with the substructure.

Further embodiments relate to an (installed) photovoltaic module with a photovoltaic module frame, a substructure and a fastener as described above, which connects the photovoltaic module frame to the substructure in a form-fit (interlocking) and force-fit manner.

Further embodiments relate to a method for fastening a photovoltaic module frame on a substructure. The method comprises the steps of:
engaging with a first engaging portion in the substructure;
engaging with at least a second engaging portion in the photovoltaic module frame; and
fixing the mounting body to the substructure with a locking element so that the photovoltaic module frame is only held to the substructure by the mounting body.

The at least one second engaging portion may again comprise four portions, each having a slot, formed as a monolithic portion in corner regions of the mounting body. The step of engaging with the at least one second engaging portion may then comprise the following:
engaging with two slots in a first photovoltaic module frame and with two further slots in a second photovoltaic module frame.

The step of fixing the mounting body can then comprise the following:
inserting the locking element between the first photovoltaic module frame and the second photovoltaic module frame,
forming a screw connection so that no component of the mounting protrudes beyond the first and/or second photovoltaic module frame.

Advantageously, the locking element is arranged strictly between the frames of the neighboring photovoltaic module frames and does not protrude beyond them.

Embodiments solve at least part of the above-mentioned problems by using a mounting body that engages in the photovoltaic module frame on the one hand and in the substructure on the other. In particular, the engagement can comprise hooking into a projection of the photovoltaic module frame so that there is no need for through-openings, holes or slots. Advantageously, the engagement is designed in such a way that the photovoltaic module frame is clamped when the mounting body is fixed, which results in the frame being firmly connected to the substructure due to a frictional connection. As a result, the photovoltaic module frame is reliably secured to the substructure without any protrusions on the photovoltaic module. In addition, the photovoltaic module frame can be fixed at various points so that the photovoltaic module frame is held firmly in place even in strong winds.

Further advantages of embodiments are that no pressure is exerted on the frame from above, which increases the tightness at the photovoltaic module edges. The appearance is also improved as there are no protruding elements.

### BRIEF DESCRIPTION OF THE FIGURES

Embodiments of the present invention will be better understood from the following detailed description and accompanying drawings, which, however, should not be construed as limiting the disclosure to the specific embodiments, but are merely for purposes of explanation and understanding.

FIG. 1 shows a fastener of a photovoltaic module frame on a substructure according to an embodiment of the present invention.

FIG. 2 shows further details of the mounting body used in the fastener according to embodiments.

FIGS. 3A,3B show a side view and a cross-sectional view through the mounting body.

FIGS. 4A,4 show further details of a frictional connection formed between the mounting body and the photovoltaic module frame according to embodiments.

FIG. 5 shows a schematic flow diagram for fastening a photovoltaic module frame on a substructure according to an embodiment of the present invention.

FIGS. 6A-6B illustrate the procedure for fastening the photovoltaic module on the substructure.

### DETAILED DESCRIPTION

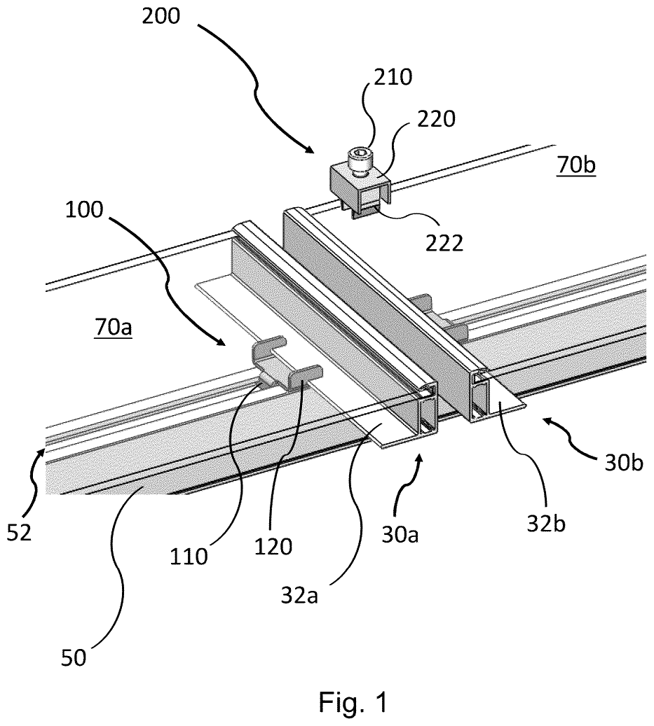

FIG. 1 shows a fastener of a photovoltaic module frame 30 on a substructure 50, wherein the photovoltaic module frame 30a holds a photovoltaic module 70a. The fastener comprises a mounting body 100 and a locking element 200. The mounting body 100 comprises one or more first engaging portions 110 and second engaging portion 120 (or at least one second engaging portion). The first engaging portions 110 engage the substructure 50 in a longitudinally formed recess 52. The second engaging portion 120 engage in a projection or protruding portion 32a of the photovoltaic module frame 30a. The protruding portion 32a extends parallel to a light incidence surface of the photovoltaic module 70 (opposite the substructure 50). The locking element 200 comprises a holding element 220 and a bolt 210 (with an optionally latching mechanism 222, e.g. with a click profile) and is located between two adjacent photovoltaic modules 70 after mounting. The locking element 200 fixes the mounting body 100 on the substructure 50 by means of the bolt 210, which can engage in a thread or a nut for this purpose, for example. FIG. 1 also shows an adjacent photovoltaic module 70b, which can be fixed to the substructure 50 using the same mounting body 100 (again via a projection 32b in the frame 30b).

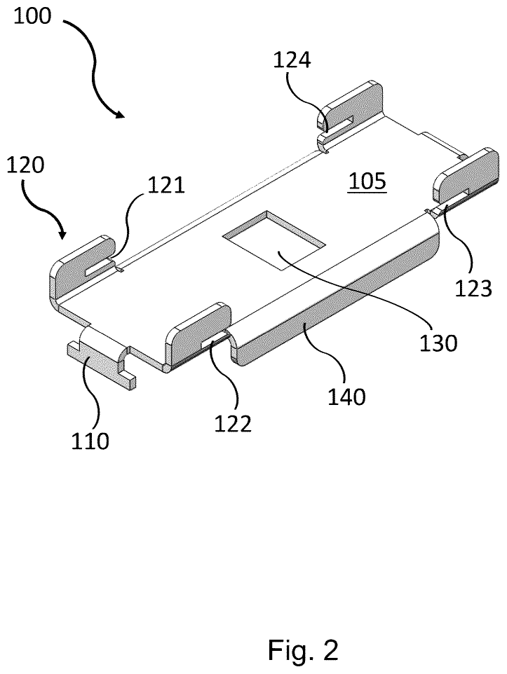

FIG. 2 shows further details of the mounting body 100. Thus, the mounting body 100 comprises a plate-shaped planar portion 105 from which the first engaging portions 110 and second engaging portion 120 extend as projections in opposite directions. The first engaging portions 110 extend from the planar portion 105 in a vertically downwardly pointing direction (i.e. towards the substructure 50, see FIG. 1), while the second engaging portion 120 point vertically upwardly (i.e. away from the substructure 50) and are formed as bent portions at corner regions of the planar portion 105.

In the embodiment shown, the second engaging portion 120 comprise four protrusions extending vertically upwardly at the corner regions of the planar portion 105 and each having a slot 121, 122, . . . , i.e. a first slot 121 at a first corner, a second slot 122 at a second corner, a third slot 123 at a third corner and a fourth slot 124 at a fourth corner. The slots 121, . . . thereby point along the longitudinal extent of the planar portion 105 and are configured to each other to receive the protruding portion 32 of the photovoltaic module frame 30 (see FIG. 1). In addition, the planar portion 105 comprises a through-opening 130 configured to receive the locking element 200.

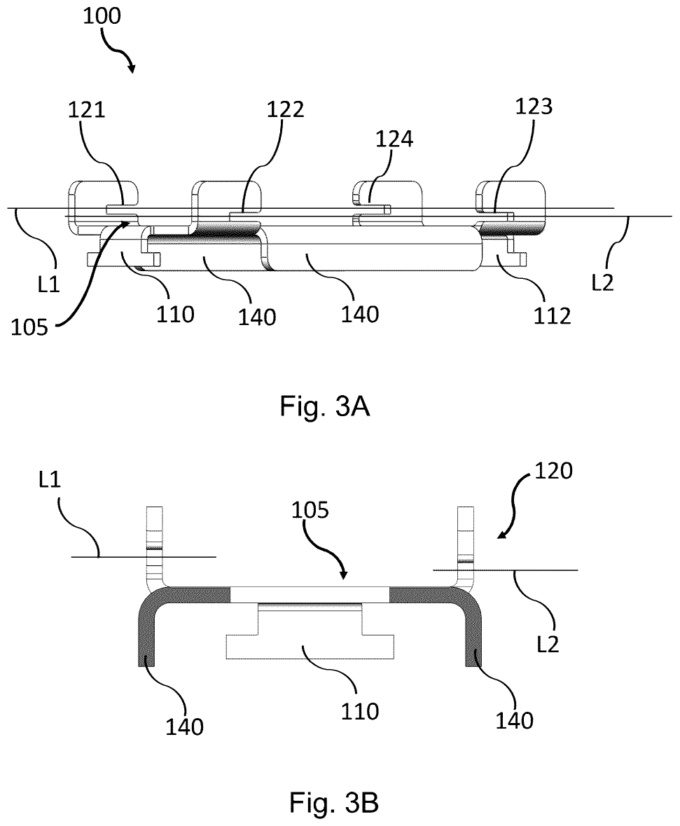

FIG. 3A shows a side view and FIG. 3B shows a cross-sectional view through the mounting body 100. From the side view it can be seen that the slots 121, . . . define a first level L1 and a second level L2 with respect to the planar portion 105, i.e. the slots at the first/second level L1, L2 are at different heights above the planar portion 105.

In addition, it can be seen in the side view of FIG. 3A that a further first engaging portion 112 is formed, which can also engage in the substructure 50. In addition, the mounting body 100 comprises protruding reinforcing sections 140 that extend in the same direction as the first engaging portions 110, 112. The reinforcing sections 140 provide a better hold on the substructure 50 and serve to stabilize the mounting, as this prevents the mounting body 100 from bending. Thus, the fastener can also withstand high loads (such as during storms).

The mounting body 100 shown can be used to fix two photovoltaic module frames 30a, 30b, each with two slots (see FIG. 1). The first slot 121 and the second slot 122 fix the first photovoltaic module frame 30a and the third slot 123 and the fourth slot 124 fix the second photovoltaic module frame 30b, wherein the first and fourth slots 121, 124 are at the first level L1 and the second and third slots 122, 123 are at the second level L2.

FIG. 3B shows a cross-sectional view through the mounting body 100. The cross-sectional view extends perpendicular to the orientation of the substructure 50, which in FIG. 3B is perpendicular to the plane of the drawing. It can be seen directly from the cross-sectional view that the first level L1 (for the first and fourth slots 121, 124) is higher than the second level L2 on the right-hand side (i.e. for the second and third slots 122, 123). This has the technical effect that an inserted photovoltaic module frame 30 is canted with the protruding portion 32 and then clamped when the locking element 200 is mounted.

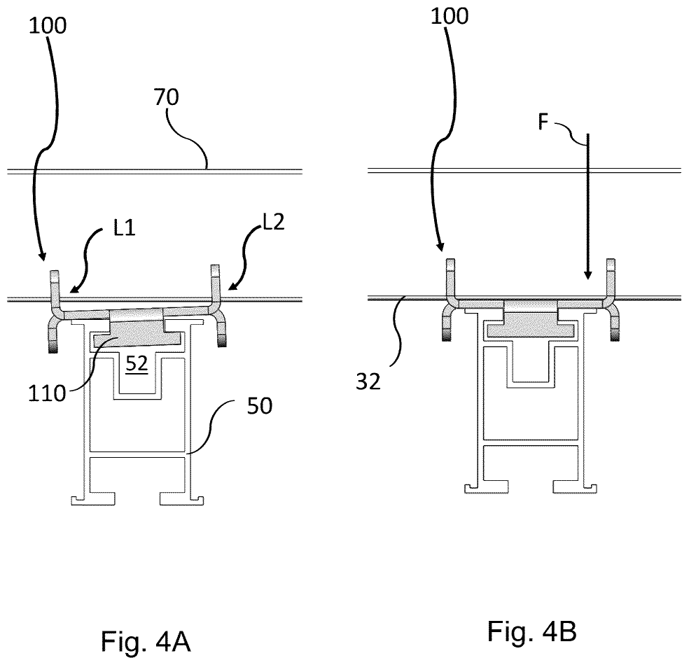

FIGS. 4A,4B show further details of this force-fitting connection by clamping. In FIG. 4A, it is first shown that due to the different levels L1 and L2, the protruding portion 32 of the photovoltaic module frame is tilted relative to the mounting body 100 and/or the mounting body 100 is tilted relative to the substructure 50. In the embodiment shown, the recess 52 is formed as a cavity-shaped broadening in the substructure 50 into which the first engaging portion 110 is inserted. The first engaging portion 110 has a clearance relative to the recess 52 (i.e. is configured to be slightly smaller) to allow tilting of the mounting body 100.

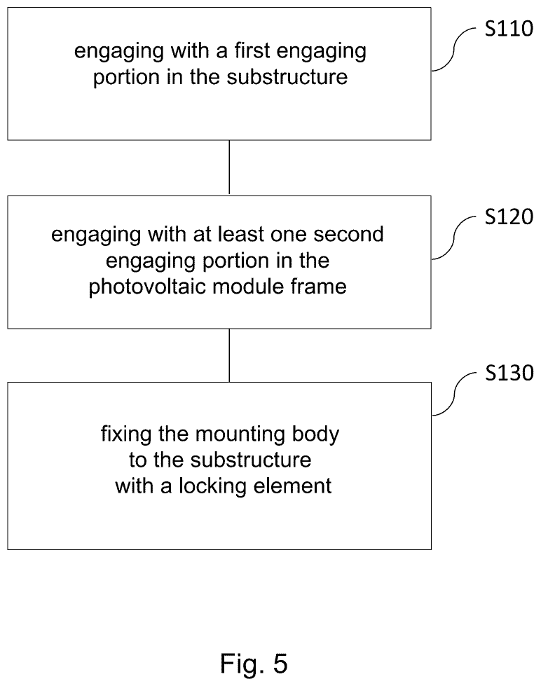

The fixation by means of the locking elements 200 presses the mounting body 100 onto the substructure 50. The force F exerted in the process (see FIG. 4B) leads to the clamping of the protruding portion 32 in the slots 121, . . . , 124 of the mounting body 100 (not shown in FIG. 5B). As a result, the photovoltaic module frame can no longer be displaced relative to the mounting body 100.

FIG. 5 schematically shows a flow diagram for a method of fastening a photovoltaic module frame 30 to a substructure 50. The method comprises the steps of:
engaging S110 with a first engaging portion 110 in the substructure 50;
engaging S120 with at least a second engaging portion 120 in the photovoltaic module frame 30; and
fixing S130 the mounting body 100 to the substructure 50 with a locking element 200, so that the photovoltaic module frame 30 is held to the substructure 50 only by the mounting body 100.

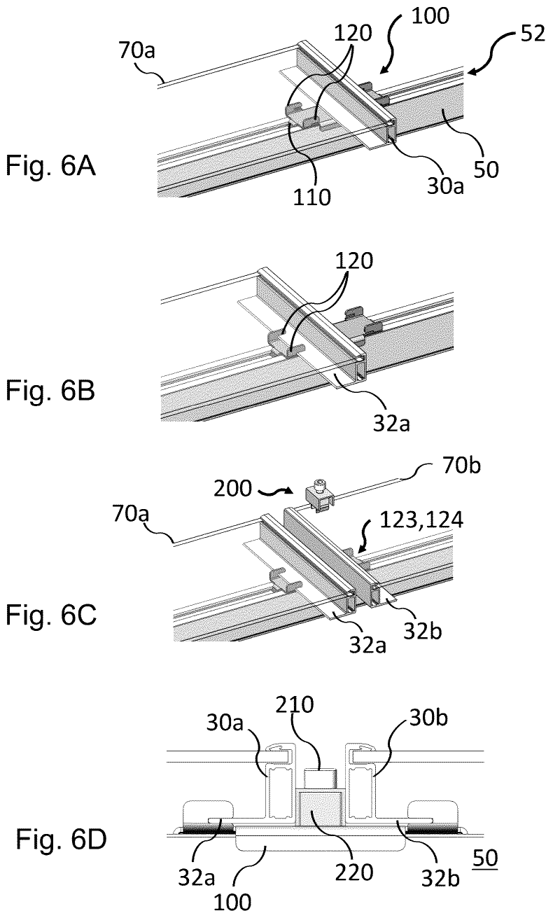

FIGS. 6A-6B illustrate further optional process steps when mounting the photovoltaic module 70 via the mounting of the photovoltaic module frame 30 on the substructure 50.

In a first step (see FIG. 6A), the mounting body 100 can be placed on the substructure 50 or inserted into the recess 52 (e.g. from one side) with the first engaging portion(s) 110. In addition, the first photovoltaic module 70a is inserted with its frame 30a between the second engaging portions 120. A rough positioning of the mounting body 100 on the substructure 50 is performed.

In the next step (see FIG. 6B), the photovoltaic module 70 with the frame 30 can be displaced to the left until the protruding portion 32 engages in the first slot 121 and the second slot 122 and is held there. Depending on the circumstances, the mounting body 100 can also be shifted to the right accordingly, with the second engaging portions 120 engaging the protruding portion 32.

In the next step (see FIG. 6C), the second, adjacent photovoltaic module 70b can be inserted with the frame 30b in the same way. There too, the second photovoltaic module 70b can be displaced until the protruding portion 32b of the second photovoltaic module frame 30b engages in the third slot 123 and the fourth slot 124.

In the last step shown (see FIG. 6D), the photovoltaic module frames 30a, 30b can be fixed to the substructure 50 by the locking element 200. For this purpose, the locking element 200 is inserted between the neighboring photovoltaic module frames 30a, 30b. The locking element 200 can engage via the exemplary latching mechanism 222 of the holding element 220 in the through-opening 130 (see FIG. 1 and FIG. 2) and be fixed there. Subsequently, the bolt 210 can be inserted into the opening and mounted in the substructure 50 using a nut or other thread.

As a result, the photovoltaic module frames 30a, 30b of two adjacent photovoltaic modules 70a, 70b are attached to the substructure 50 via only one mounting body 100 using the locking element 200.

An advantage of embodiments is that the fastener provides an interlocking connection together with a force-fitting connection, wherein the interlocking connection is effected by the first and second engaging portions 110, 120 and the force-fitting connection is effected by the clamping of the protruding portion 32a, 32b in the photovoltaic module frames 30a, 30b in slots 121, 122. For this purpose, the slots 121 . . . 124 are formed at different levels or Levels L1, L2 (see FIG. 4).

This offers the further advantage that reliable mounting with only one mounting body 100 is possible for adjacent photovoltaic module frames 30a, 30b without the need to form openings, holes or cuts in the photovoltaic module frames 30, as would be required, for example, by conventional screw connections to the substructure 50. The openings, holes or cuts would have the disadvantage of being a potential source of damage (e.g. due to cracks, corrosion or the like). Embodiments avoid this.

It is understood that all the functions described above can be optionally designed as method steps. It is also understood that the order in which they are mentioned does not necessarily imply an order in which the method steps are carried out. The steps can also be carried out in a different order.

The features of the invention disclosed in the description, the claims and the Figures may be essential for the realization of the invention either individually or in any combination.

### LIST OF REFERENCE SYMBOLS

30 photovoltaic module frame
32 protruding portion (projection)
50 substructure
52 recess (groove, recess, slot)
70 photovoltaic module
100 mounting body
105 planar portion (section)
110,112 first engaging portion(s)
120 at least a second engaging portion
121, 122, . . . slots
130 through-opening
140 reinforcement section
200 locking element
210 bolt or screw element
220 holding element (holding section)
222 latching mechanism
L1, L2 different levels

1. Fastener for photovoltaic module frames on a substructure, wherein the fastener comprises the following:
a mounting body having a first engaging portion for engaging the substructure and at least one second engaging portion for engaging the photovoltaic module frame; and
a locking element for fixing the mounting body to the substructure, so that when the mounting is effected in this way, the photovoltaic module frame is held to the substructure only via the mounting body.

2. Fastener according to claim 1, wherein the mounting body has a planar portion, and the photovoltaic module frame has a protruding portion extending parallel to a light incidence surface of an installed photovoltaic module, and
wherein the at least one second engaging portion comprises a first portion having a first slot and a second portion having a second slot bent from the planar portion of the mounting body, and the first slot and the second slot are formed at different levels with respect to the planar portion to receive and clamp the protruding portion of the photovoltaic module frame when fixed by the locking element.

3. Fastener according to claim 1, wherein the at least one second engaging portion comprises four portions each having a slot formed as a monolithic part in corner regions of the mounting body, of which two slots are configured to grip a first photovoltaic module frame and two further slots are configured to grip a second photovoltaic module frame, and
wherein the locking element is configured to form a spacer between the first photovoltaic module frame and the second photovoltaic module frame.

4. Fastener according to claim 1,
wherein the mounting body has a through-opening, and the locking element has a bolt and a holding element,
wherein the bolt can be guided through the through-opening and the holding element, and wherein the holding element together with the bolt has a T-shape in order to hold the mounting body by locking the through-opening, and wherein the holding element has a smaller extension along a direction of incidence of light than the photovoltaic module frame.

5. Fastener according to claim 4, wherein the holding element comprises a latching mechanism configured to latch into the through-opening or into the substructure to block the photovoltaic module frame from sliding out of the second engaging portion.

6. Fastener according to claim 1, wherein the substructure comprises a recess, in particular a through-opening or a longitudinally extending groove, and the first engaging portion and/or the recess is/are configured to provide an interlocking connection between the substructure and the first engaging portion.

7. Fastener according to claim 6, wherein the mounting body comprises a further first engaging portion, wherein the first engaging portion and the further first engaging portion are configured as T-shaped projections at opposite ends of the mounting body in order to be able to hook both into the recess.

8. Fastener according to claim 1, wherein the mounting body comprises at least one reinforcing section extending from the mounting body in a same direction as the first engaging section.

9. Fastener according to claim 1, wherein the mounting body comprises a planar portion, from which the first engaging portion and the at least one second engaging portion each extend as a projection in opposite directions, wherein after mounting the planar portion constitutes a spacer between the photovoltaic module frame and the substructure.

10. Photovoltaic module with a photovoltaic module frame, a substructure and a fastener according to claim 1, which connects the photovoltaic module frame to the substructure in an interlocking and force-fitting manner.

11. Method for fastening a photovoltaic module frame on a substructure, comprising the following steps:
engaging with a first engaging portion in the substructure;
engaging with at least a second engaging portion in the photovoltaic module frame; and
fixing the mounting body to the substructure with a locking element, so that the photovoltaic module frame is held to the substructure only by the mounting body.

12. The method according to claim 11, wherein the at least one second engaging portion comprises four portions each having a slot formed as a monolithic part in corner regions of the mounting body, and the step of engaging with the at least one second engaging section comprises the following:
engaging with two slots in a first photovoltaic module frame and with two further slots in a second photovoltaic module frame, and the step of fixing the mounting body comprises the following:
inserting the locking element between the first photovoltaic module frame and the one second photovoltaic module frame and forming a screw connection so that no component of the fastener protrudes beyond the first and second photovoltaic module frames.
